(19) United States
(12) Patent Application Publication
(10) Pub. No.: US 2007/0263338 A1
(43) Pub. Date: Nov. 15, 2007

(54) CORONA DISCHARGE TYPE IONIZER AND FAN UNIT

(75) Inventors: Hirotaka NAKASHIMA, Fukuchiyama-shi (JP); Taketo YASUZUMI, Kameoka-shi (JP); Nobuharu ISHIKAWA, Osaka (JP); Kohei TOMITA, Kyoto-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/746,954

(22) Filed: May 10, 2007

(30) Foreign Application Priority Data
May 11, 2006 (JP) JP2006-132439

(51) Int. Cl. H01H 47/00

(52) U.S. Cl. 361/220

(57) ABSTRACT

The corona discharge type ionizer has an airflow sensor disposed on an air path and a CPU (corona discharge control part) which stops discharge operation of discharge needles when it is determined from an output signal of the airflow sensor that airflow on the air path is lowered to a set value or less.

### BACKGROUND OF THE INVENTION

This application claims priority from Japanese Patent Application JP2006-132439, filed on May 11, 2006. The entire contents of the aforementioned application is incorporated herein by reference.

1. Field of the Invention

The present invention relates to a corona discharge type ionizer which ionizes air in a clean room by corona discharge of discharge needles and neutralizes electrostatic charges on a surface of an object to be processed by the ions, a fan unit which blows clean air to the corona discharge type ionizer through an air blowing port of the ionizer, and a clean room system which makes air in a clean room inner area by using the ionizer and the fan unit.

2. Description of the Related Art

In manufacturing of semiconductors and liquid crystal devices, to improve yields, it is required to remove dusts from air surrounding the devices, thereby producing clean (pure) air. For this reason, the devices are generally manufactured in clean rooms or clean booths which are controlled in a clean air environment (collectively referred to as clean room). Conceptually, the clean room contains a local clean room provided inside the clean room to further clean the air locally. The clean room has a fan unit including a blower fan and a dust filter on an upper surface of a room roof plate, and introduces air thereinto from an air blowing port of the fan unit through an opening formed on the room roof plate. Generally, the air introduced into the clean room is guided to the outside of the clean room, cleaned by the fan unit again and returned into the clean room.

When a semiconductor device or liquid crystal device is charged with static electricity in such a clean room, various particles containing dusts adhere to the device due to the static electricity. As a result, problems such as degradation in quality of the manufactured device occur. However, it is difficult to remove the dusts adhering due to the static electricity only by means of airflow. In addition, there is a possibility that an IC and the like in the semiconductor or the liquid crystal device are subjected to electrostatic discharge damage. Thus, in addition to the fan unit, an ionizer for removing static electricity (static elimination) is conventionally provided at the opening of the roof (see Japanese Patent Application Laid-open No. 09-73993).

As publicly known, by neutralizing electrostatic charges on the surface of the device with ions of opposite polarity which are generated by corona discharge of discharge needles, the ionizer removes the static electricity from the surface of the device.

The corona discharge type ionizer generates a small amount of ozone into the air by corona discharge, and the generated ozone convects or circulates due to the blowing of the fan unit, thereby having little impact on the environment. However, when the blowing of the fan unit is stopped or the airflow is lowered to or below a set value, the ozone becomes difficult to convect or circulate by blowing. As a result, highly concentrated ozone is locally accumulated, which possibly has a harmful effect on human body.

### SUMMARY OF THE INVENTION

A problem to be solved by the present invention is to remove the accumulation of ozone by controlling the corona discharge operation of the corona discharge type ionizer based on the state of airflow to the corona discharge type ionizer and the state of blowing of the fan unit.

(1) A corona discharge type ionizer according to the present invention is a corona discharge type ionizer provided with a discharge needle for performing corona discharge by application of high voltage on an air path or in the periphery of the air path including an airflow sensor disposed on the air path and a corona discharge control part for stopping a discharge operation of the discharge needle when it is determined from an output signal of the airflow sensor that an airflow on the air path is lowered to or below a set value.

The airflow sensor is not limited in type and may be disposed at any position on the air path.

The corona discharge control part may be constituted by a control part such as a CPU for controlling a high voltage generation part which supplies a high voltage to the discharge needle or by a control part provided separately from this control part. The corona discharge control part may directly control the operation of the high voltage generation part, for example, by stopping the operation of the high voltage generation part or stopping power supply to the high voltage generation part, or may directly control the discharge needle when the operation of the high voltage generation part is not stopped. For example, the control may be carried out such that corona discharge of the discharge needles may not be performed by providing an electronic or mechanical contact between the high voltage generation part and the discharge needle and turning on/off the contact.

According to the present invention, when an airflow on the air path is lowered to or below a set value, the discharge operation of the discharge needle is stopped. For example, when stoppage or abnormality in the blowing operation of the fan unit occurs and thus, the airflow on the air path is lowered to or below the set value, the discharge operation of the discharge needle is stopped. As a result, there is no possibility that corona discharge occurs in a no-blowing state, resulting in the accumulation of ozone.

(2) According to one aspect of the present invention, the corona discharge control part has a high voltage generation part which generates a high voltage necessary for corona discharge of the discharge needle and supplies the generated high voltage to the discharge needle, and stops an operation of the high voltage generation part, thereby stopping the discharge operation of the discharge needle. According to this aspect, the discharge operation of the discharge needle can be reliably stopped.

(3) A corona discharge type ionizer according to the present invention has a blower fan, a blowing operation control part for controlling a blowing operation of the blower fan, and a blowing state detection part for detecting stoppage or abnormality of the blowing operation of the blower fan. The corona discharge control part stops the discharge operation of the discharge needle when it is determined from an output signal of the blowing state detection part that stoppage or abnormality of blowing of the blower fan occurs.

The blowing state detection part includes, for example, a power on/off sensor for the blower fan, a rotation rate sensor for the blower fan, a filter clogging sensor, and a clean room differential sensor.

According to this aspect, since power supply to the ionizer can be stopped on the side of the fan unit as a blower, the discharge operation of the discharge needle can be reliably stopped in response to stoppage or abnormality of blowing on the side of the ionizer together with the airflow sensor.

(4) According to one aspect of the present invention, the corona discharge type ionizer is provided separately from a fan unit having the blower fan, the blowing operation control part, the blowing state detection part and a power supply output part for outputting power to the outside, is held between a clean room partition plate and the fan unit in an outer area of the clean room and to which a cable for inputting power to the corona discharge control part for the power supply output part in the fan unit is detachably connected.

According to this aspect, since the ionizer and the fan unit can be integrally installed on the clean room partition plate in the clean room, works for the installation is advantageously simplified.

(5) A corona discharge type ionizer according to the present invention is a corona discharge type ionizer provided with a discharge needle for performing corona discharge by application of a high voltage on an air path or in the periphery of the air path including a corona discharge control part for fetching data on whether or not stoppage or abnormality of blowing on the air path occurs and stopping a discharge operation of the discharge needle when it is determined from the fetched data that stoppage or abnormality of blowing occurs.

According to this aspect, in the fan unit as a blower, the data may be transmitted to the ionizer through wired or wireless transmission.

(6) A fan unit according to the present invention is a fan unit disposed on the air path in the corona discharge type ionizer as a blower to blow air on the air path including a filter, a blower fan, a blowing operation control part for controlling a blowing operation of the blower fan, and a blowing state detection part for detecting stoppage or abnormality of the blowing operation of the blower fan. The blowing operation control part controls to stop corona discharge of the corona discharge type ionizer or controls to output data for the stoppage when it is determined from an output signal from the blowing state detection part that stoppage or abnormality of the blowing operation of the blower fan occurs.

(7) A clean room system according to the present invention has a fan unit and a corona discharge type ionizer disposed in front of an air blowing port of the fan unit. The corona discharge type ionizer according to any one of the aforementioned (1) to (5) is held between the clean room partition plate and the fan unit in an outer area of the clean room.

The clean room partition plate is a plate for defining inside and outside of a local clean room when the local clean room is provided in the clean room, and is a plate for defining inside and outside of a clean room in the case of the general clean room without the local clean room. The shape of the plate is not limited to a board, and may be a sheet, a film or a screen. A material for the clean room partition plate is also not limited.

For example, the ionizer can be held between the fan unit and the clean room partition plate by placing the lower surface of the ionizer on the upper surface of the clean room partition plate and placing the fan unit on the upper surface of the ionizer.

According to the present invention, it is possible to avoid or eliminate such a situation in which ozone is accumulated by corona discharge of the ionizer in the case of abnormality in the blowing state on the air path.

### BRIEF DESCRIPTION OF THE DRAWINGS

FIG. 1 shows a schematic configuration of a clean room facility in accordance with an embodiment of the present invention;

FIG. 2 shows an enlarged front view of an ionizer and a fan unit which are stacked on a clean room partition plate in FIG. 1;

FIG. 3 shows a perspective view of FIG. 2 when viewed from diagonally above;

FIG. 4 shows a perspective view of the ionizer and the fan unit in FIG. 3 in a separate manner;

FIG. 5 shows a perspective view of the ionizer and the fan unit in a stacked state when viewed from diagonally below;

FIG. 6 shows a perspective view of the ionizer and the fan unit in FIG. 5 in a separate manner;

FIG. 7 shows a plan view of a state in which circuit components are housed within hollow casing frames of the ionizer, where an upper half of the hollow casing frames are removed; and

FIG. 8 shows a circuit diagram of the fan unit and the ionizer.

### DETAILED DESCRIPTION OF THE PREFERRED EMBODIMENTS

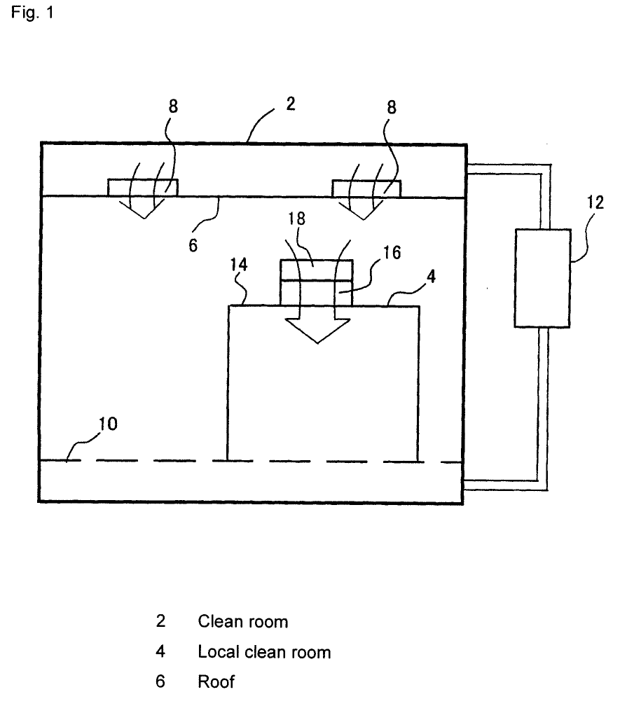

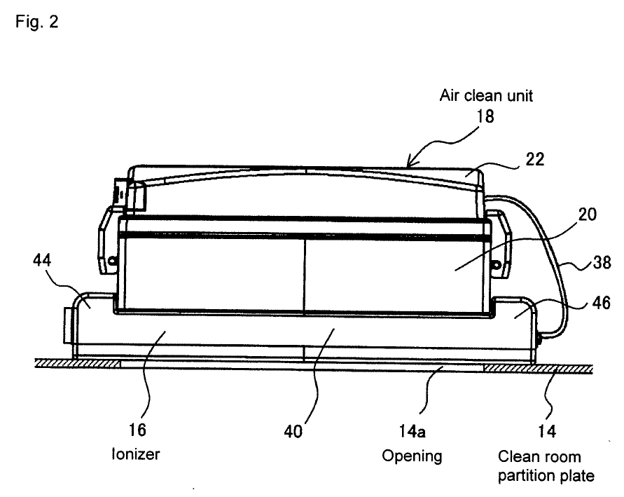

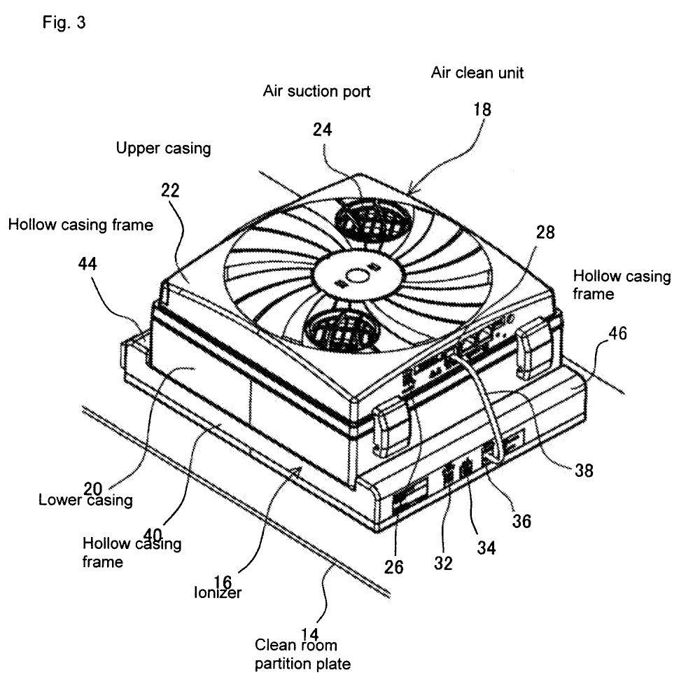

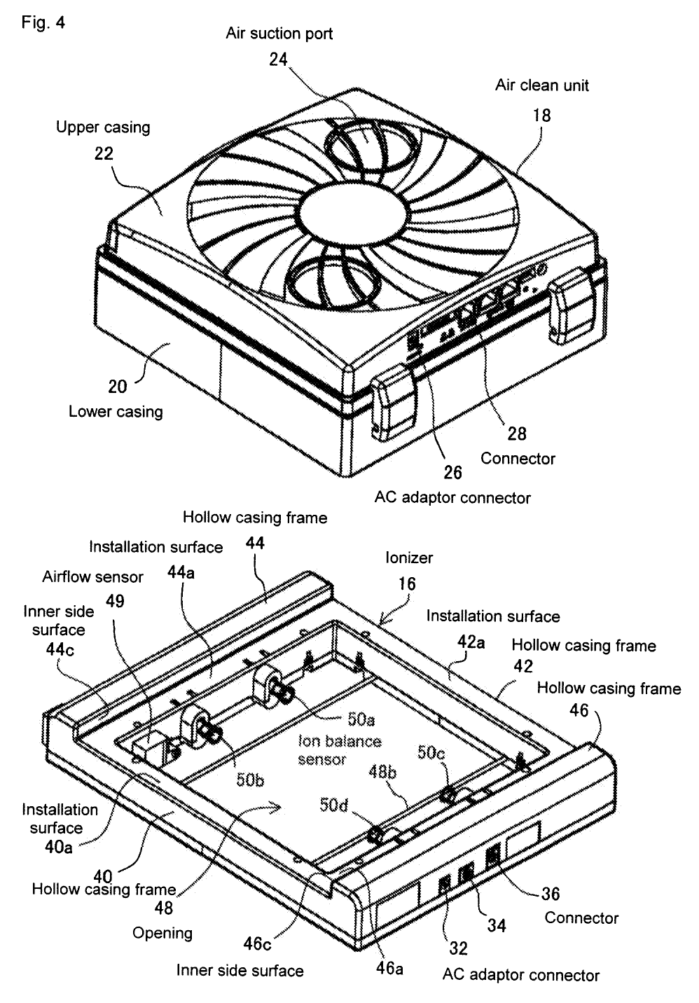

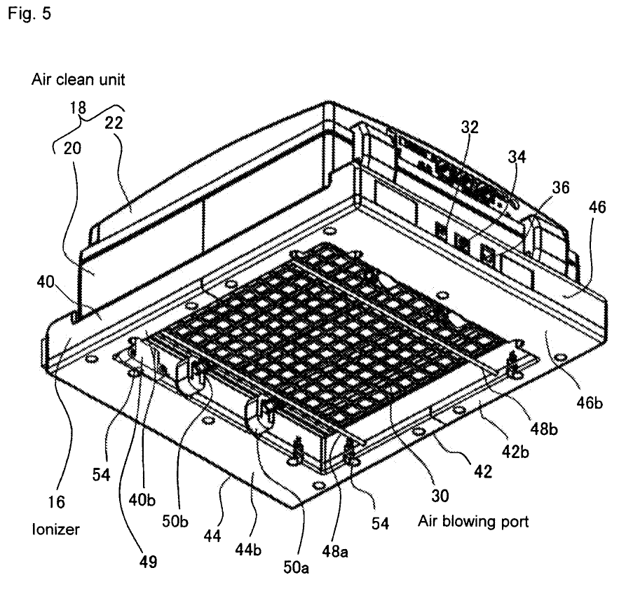

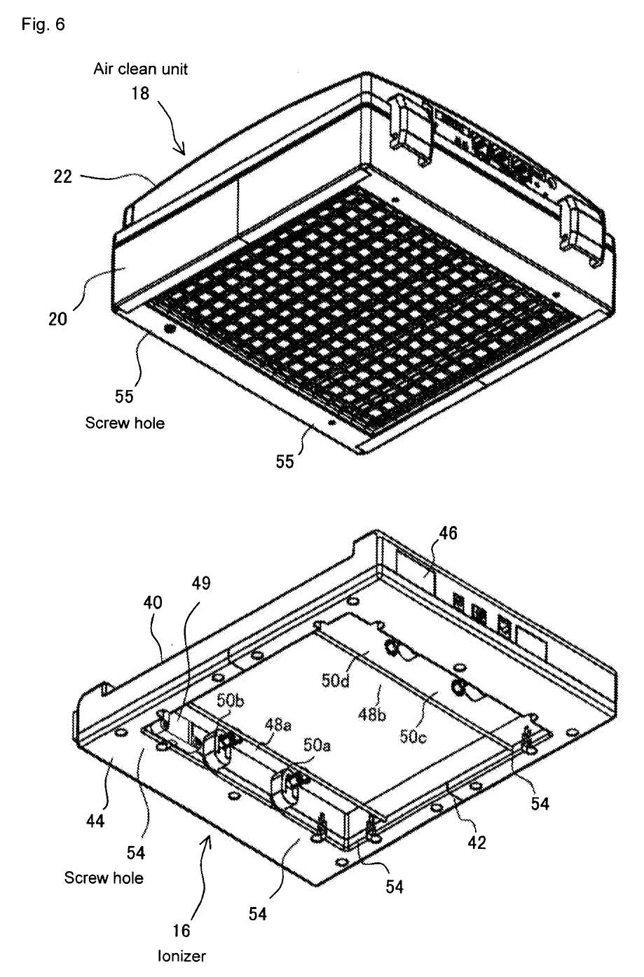

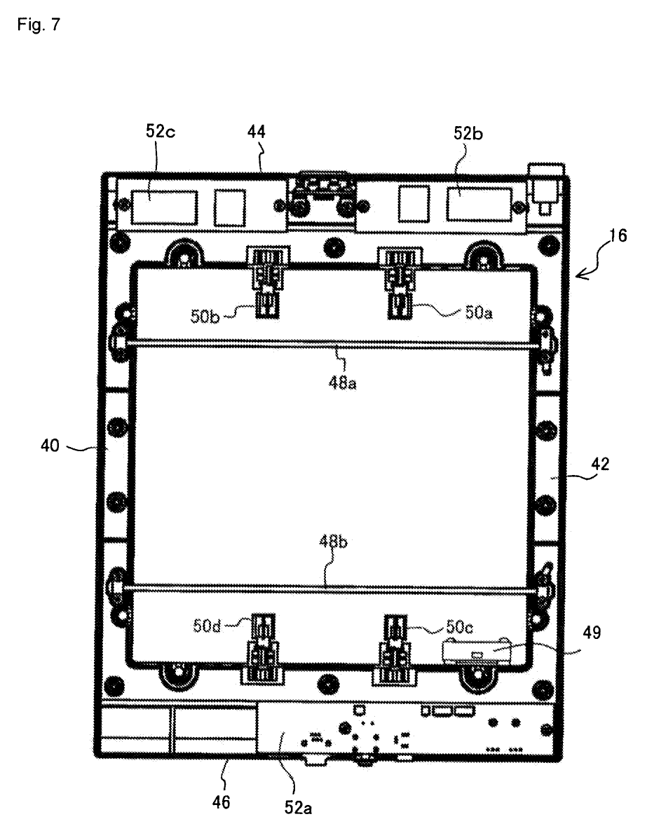

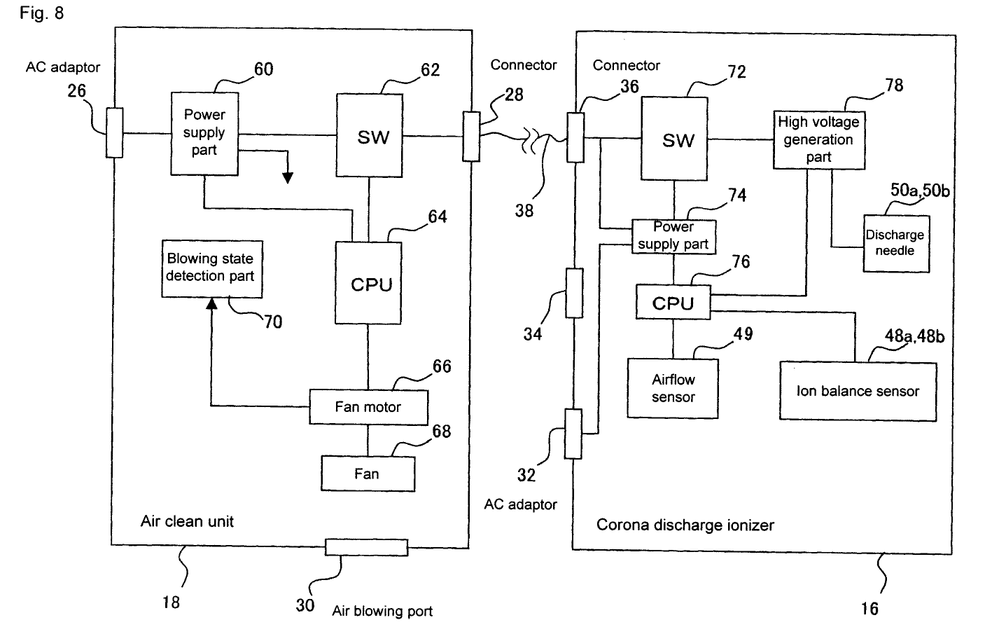

Hereinafter, an ionizer, a fan unit and a clean room facility in accordance with an embodiment of the present invention will be described with reference to the accompanying drawings. FIG. 1 shows a schematic configuration of the clean room facility, FIG. 2 shows an enlarged front view of the ionizer and the fan unit which are stacked on a clean room partition plate in FIG. 1, FIG. 3 shows a perspective view of FIG. 2 when viewed from diagonally above, FIG. 4 shows a perspective view of the ionizer and the fan unit in FIG. 3 in a separate manner, FIG. 5 shows a perspective view of the ionizer and the fan unit in a stacked state when viewed from diagonally below, FIG. 6 shows a perspective view of the ionizer and the fan unit in FIG. 5 in a separate manner, FIG. 7 shows a plan view of a state in which circuit components are housed within hollow casing frames of the ionizer where an upper half of the hollow casing frames are removed, and FIG. 8 shows a circuit diagram of the fan unit and the ionizer.

First, referring to FIG. 1, in the clean room facility, a local clean room 4 is provided in a clean room 2. In the clean room 2, a fan unit 8 constituted by a fan and a high performance filter is provided on a roof 6, a perforated floor plate 10 is provided and air-conditioning air is supplied from the back surface of the roof 6 by an air conditioner 12 to form a required clean space (pure space) in the clean room 2. The local clean room 4 is surrounded by a clean room partition plate 14, and an ionizer 16 and a local fan unit 18 are placed on the upper portion of a clean room partition plate 14 (outer area of the clean room) in a stacked manner. By supplying clean air into the local clean room 4 (inner area of the clean room) by the fan unit 18, a required processing can be performed to an object to be processed such as a semiconductor wafer and a liquid crystal device (not shown) placed in the local clean room 4.

The ionizer 16 is mounted on the clean room partition plate 14 of the local clean room 4. The fan unit 18 is mounted on the ionizer 16. Thus, the ionizer 16 is held between the clean room partition plate 14 and the fan unit 18.

Referring to FIG. 2 and subsequent drawings, the fan unit 18 is formed of a lower casing 20 and an upper casing 22 in the shape of a rectangular box. The upper casing 22 has an air suction port 24 on its upper surface, and an AC adaptor connector 26 and an ionizer connector 28 on its side surface. The lower casing 20 has a mesh-like air blowing port 30 on its lower surface.

The ionizer 16 has an AC adaptor connector 32, a ground terminal 34 and a fan unit connector 36, which are used when power is not supplied from the fan unit 18, on its side surface. In the figures of this embodiment, the ionizer connector 28 of the fan unit 18 is connected to the fan unit connector 36 of the ionizer 16 via a power/signal input/output cable 38 so that power can be supplied to the AC adaptor connector 26 of the fan unit 18 and then, supplied from the fan unit 18 to the ionizer 16.

Various filters such as a dust filter and an HEPA filter and a fan which is rotatably driven by a motor are provided between the air suction port 24 and the air blowing port 30 in the fan unit 18.

The fan unit 18 has a blowing state detection part not shown as a blower. The blowing state detection part is provided with, for example, a power on/off sensor for the fan as a blower, a rotation rate sensor for the fan, a filter clogging sensor, and a clean room differential sensor.

The ionizer 16 has a hollow casing structure in the shape of a rectangular frame. This hollow casing structure is formed by a pair of first and second hollow casing frames 40, 42 which are opposed to each other in parallel and a pair of third and fourth hollow casing frames 44, 46 which are perpendicular to the first and second hollow casing frames 40, 42 and opposed to each other in parallel, in the shape of a rectangular frame. A rectangular opening 48 is formed inside these surrounding four hollow casing frames 40 to 46.

Two wire-like ion balance sensors 48a, 48b are extended between the inner side surfaces of the first and second hollow casing frames 40, 42. Discharge needles 50a to 50d are provided on the inner side surfaces of the third and fourth hollow casing frames 44, 46 to protrude toward the opening 48.

An airflow sensor 49 for detecting airflow from the fan unit 18 as a blower is provided on an air path on the inner side surface of the hollow casing frame 44. The number of the airflow sensor 49 is one or more.

The first and second hollow casing frames 40, 42 have a rectangular cross-section and a narrow width. Each of the third and fourth hollow casing frames 44, 46 has a difference in level between its inner periphery and its outer periphery, with the outer periphery made higher, and has an L-shaped cross-section. Frame-like installation surfaces where the lower surface of the fan unit 18 is installed are formed by upper surfaces 40a, 42a of the first and second hollow casing frames 40, 42 and upper surfaces 44a, 46a on the inner peripheral side of the third and fourth hollow casing frames 44, 46. The installation surfaces 40a, 42a, 44a, 46a are flat, allowing close contact against the lower surface of the fan unit 18. Frame-like installation surfaces 40b, 42b, 44b, 46b for installing the ionizer 16 on the upper surface of the clean room partition plate 14 are formed by lower surfaces 40b, 42b of the first and second hollow casing frames 40, 42 and lower surfaces 44b, 46b of the third and fourth hollow casing frames 44, 46. The installation surfaces are flat, allowing close contact against the upper surface of the clean room partition plate 14. Both the installation surfaces are preferably provided with a cushion member not shown. An elastic member such as rubber and a double-faced tape may be used as the cushion member.

The fan unit 18 is installed on the upper surfaces of the first and second hollow casing frames 40, 42 and the upper surfaces on the inner peripheral side of the third and fourth hollow casing frames 44, 46, and positioned by being held between the inner side surfaces 44c, 46c of the third and fourth hollow casing frames 44, 46. Circuit components 52a, 52b, 52c and wirings (not shown) of the ionizer 16 are housed in the first to fourth hollow casing frames 40 to 46.

The circuit components 52a, 52b, 52c of the ionizer 16 are circuit components including a power supply part, a high voltage generation control part, a positive high voltage generation part and a negative high voltage generation part. Screw holes 54 penetrating the clean room partition plate 14 in the vertical direction are formed in the ionizer 16. Screw holes 55 corresponding to the screw holes 54 are formed in the fan unit 18. The screw holes 55 are subjected to tapping such as serial tap and ordinary tap.

Hereinafter, circuits of the fan unit 18 and the ionizer 16 will be described with reference to FIG. 8. The fan unit 18 has a power supply part 60 which converts AC power supply from the AC adaptor connector 26 into direct currents of, e.g. 24V and 5V and supplies the currents to the circuit in the fan unit 18 as well as the ionizer 16, a switch part 62 which outputs the direct current of 24V sent from the power supply part 60 to the connector 28, a CPU (control part) 64 which receives the direct current of 5V from the power supply part 60 to control the inside of the fan unit 18, a fan motor 66 which receives a necessary drive voltage from the power supply part 60 and a rotational action of which is controlled by the CPU 64, a fan (blowing part) 68 which is rotatably driven by the fan motor 66, and a blowing state detection part 70 which detects the blowing state of an air blowing port 30. Reference numerals 28, 36 denote connectors of the fan unit 18 and the ionizer 16, respectively. The connector 28 forms a power supply output part and the connector 36 forms a power supply input part.

The blowing state detection part 70 detects stoppage and abnormality of the blowing of the fan 68. Although not shown in detail, the blowing state detection part 70 includes a power on/off sensor for the fan motor 66, a rotation rate sensor for the fan 68, a filter clogging sensor and a clean room differential sensor.

When the CPU 64 determines stoppage or abnormality of the blowing based on an output signal from the blowing state detection part 70, the CPU 64 controls the switch part 62 to be turned off. In this manner, the power supply to the ionizer 16 is blocked, thereby forcibly stopping the corona discharge operation of the ionizer 16.

The ionizer 16 has a switch part 72, a power supply part 74 which converts the direct current of 24V from the connector 36 into the direct current of 5V, a CPU (corona discharge control part) 76 which receives power from the power supply part 74 to control the overall operation of the ionizer 16, an airflow sensor 49 which is disposed on the air path in front of the air blowing port of the fan unit 18 and detects the airflow, a high voltage generation part 78 which generates a high voltage necessary for corona discharge of the discharge needles 50a to 50d from the direct current of 24V supplied via the switch part 72 under the control of the discharge needles 50a to 50d and the CPU 76 and supplies the generated high voltage to the discharge needles 50a to 50d, and ion balance sensors 48a, 48b which detect the state of balance between plus ions and minus ions generated by the corona discharge of the discharge needles 50a to 50d and output a signal relating to the detection to the CPU 76.

Although the control operation of the CPU 76 on the overall ionizer 16 is not described in detail, when it is determined from the output signal of the airflow sensor 49 that the airflow on the air path is lowered to or below a set value (a value stored in a storage part not shown), the CPU 76 controls the high voltage generation part 78 to stop the high voltage generating operation, thereby stopping the discharge operation of the discharge needles 50a to 50d.

The blowing state detection data may be transmitted from the fan unit 18 to the CPU 76 of the ionizer 16 via transmission means not shown, and when it is determined from the data that stoppage or abnormality of the blowing in the fan unit 18 occurs, the CPU 76 may stop the operation of the high voltage generation part 78.

As described above, in the present embodiment, on the side of the fan unit 18, when the blowing state detection part 70 detects stoppage or abnormality in the blowing of the fan 68, the CPU 64 blocks the switch part 62, thereby stopping high voltage generation by the high voltage generation part 78 of the ionizer 16, resulting in stoppage of the corona discharge operation by the discharge needles 50a to 50d. When the airflow sensor 49 detects that the airflow on the air path to the ionizer 16 is lowered to or below the set value, the CPU 76 stops the high voltage generation by the high voltage generation part 78, resulting in stoppage of the corona discharge operation by the discharge needles 50a to 50d.

As a result, even when the blowing operation of the fan unit 18 as a blower or abnormality occurs in the blowing operation and thus the airflow on the air path to the ionizer 16 is lowered to the set value or less, the discharge operation of the discharge needles 50a to 50d does not continue, thereby preventing ozone from accumulating due to corona discharge in the no-blowing state.

What is claimed is:

1. A corona discharge type ionizer provided with a discharge needle for performing corona discharge by application of a high voltage on an air path or in the periphery of the air path comprising:
a corona discharge control part for fetching data on whether or not stoppage or abnormality of blowing on the air path occurs and stopping a discharge operation of the discharge needle when it is determined from the fetched data that stoppage or abnormality of blowing occurs.

2. A corona discharge type ionizer according to claim 1 including an airflow sensor disposed on the air path; wherein
the corona discharge control part stops a discharge operation of the discharge needle when it is determined from an output signal from the airflow sensor that an airflow on the air path is lowered to a set value or less.

3. A corona discharge type ionizer according to claim 2, wherein
the corona discharge control part has a high voltage generation part which generates a high voltage necessary for corona discharge of the discharge needle and supplies the generated high voltage to the discharge needle, and stops an operation of the high voltage generation part, thereby stopping the discharge operation of the discharge needle.

4. A corona discharge type ionizer according to claim 1 including:
a blower fan;
a blowing operation control part for controlling a blowing operation of the blower fan; and
a blowing state detection part for detecting stoppage or abnormality of the blowing operation of the blower fan; wherein
the corona discharge control part stops the discharge operation of the discharge needle when it is determined from an output signal from the blowing state detection part that stoppage or abnormality of blowing of the blower fan occurs.

5. A corona discharge type ionizer according to claim 4, wherein the corona discharge type ionizer is provided separately from a fan unit having the blower fan, the blowing operation control part, the blowing state detection part and a power supply output part for outputting power to the outside, is held between a clean room partition plate and the fan unit in an outer area of the clean room and to which a cable for inputting power to the corona discharge control part for the power supply output part in the fan unit is detachably connected.

6. A fan unit disposed on the corona discharge type ionizer according to claim 1 as a blower to blow air on the air path, comprising:
a blower fan;
a blowing operation control part for controlling a blowing operation of the blower fan; and
a blowing state detection part for detecting stoppage or abnormality of the blowing operation of the blower fan;
wherein the blowing operation control part controls to stop corona discharge of the corona discharge type ionizer or controls to output data for the stoppage when it is determined from an output signal from the blowing state detection part that stoppage or abnormality of the blowing operation of the blower fan occurs.
